(19) United States
(12) Patent Application Publication
(10) Pub. No.: US 2011/0053135 A1
(43) Pub. Date: Mar. 3, 2011

(54) GAMING TECHNOLOGY TRAINING AND SKILL DEVELOPMENT SYSTEM

(75) Inventors: Steven R. Cramer, Mundelein, IL (US); Cris Challender, Lake in the Hills, IL (US)

(73) Assignee: WMS Gaming Inc.

(21) Appl. No.: 12/312,441

(22) PCT Filed: Nov. 8, 2007
(86) PCT No.: PCT/US07/23500

§ 371 Date: May 8, 2009

Related U.S. Application Data
(60) Provisional application No. 60/857,989, filed on Nov. 10, 2006.

(51) Int. Cl. G09B 25/00

(52) U.S. Cl. 434/365

(57) ABSTRACT

Disclosed is a an interactive multimedia-based gaming technology training and skill development system. The system can be accessed at almost any time and from almost anywhere a computing device may be located. Furthermore, the system can operate to present its materials in a user-paced and on-demand fashion. The gaming technology training and skill development system of the present invention allows for the system operator to bundle courses of specific interest together to form certification tracks. Additionally, the system allows the operator to assign certification exams to the certification tracks, the certification exams may feature exercises which mimic or faithfully replicate the practical exercises which they endeavor to test. Since the system maintains records for the users, the system operator can run reports that track user's activity and monitor progress real-time.

### RELATED APPLICATION

This patent application claims the priority benefit of U.S. Provisional Patent Application Ser. No. 60/857,989 filed Nov. 10, 2006 and entitled “GAMING TECHNOLOGY TRAINING AND SKILL DEVELOPMENT SYSTEM”, which application is incorporated herein by reference.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2006, 2007, WMS Gaming, Inc.

### FIELD

This invention relates generally to wagering game system training, and more particularly to systems for providing gaming technology training and skill development.

### BACKGROUND

Wagering game machine makers continually provide new and entertaining games. One way of increasing entertainment value associated with casino-style wagering games (e.g., video slots, video poker, video black jack, and the like) includes offering a variety of base games and bonus events. However, despite the variety of base games and bonus events, players often lose interest in repetitive wagering gaming content. In order to maintain player interest, wagering game machine makers frequently update wagering game content with new game themes, game settings, bonus events, game software, and other electronic data.

When distributing new wagering game content to wagering game machines in the field, wagering game machine operators typically engage in a series of training exercises with the wagering game machine technicians. Additionally, there is frequently a desire on the part of the wagering game machine operator that the wagering game machine technicians meet general levels of technical competence. For wagering game machine operators owning scores of machines and employing dozens of technicians, the required training can be relatively laborious and expensive.

### BRIEF DESCRIPTION OF THE FIGURES

Embodiments of the invention are illustrated by way of example and not limitation in the Figures of the accompanying drawings in which:

FIG. 1 is a block diagram illustrating a wagering game machine architecture, according to example embodiments of the invention;

FIG. 2 is a block diagram illustrating a wagering game framework, according to example embodiments of the invention;

FIG. 3 is a block diagram illustrating a wagering game network, according to example embodiments of the invention;

FIG. 4 is a perspective view of a wagering game machine, according to example embodiments of the invention;

FIG. 5 is a perspective view of a wagering game machine, according to example embodiments of the invention;

FIG. 6 is a block diagram of an exemplary computer architecture on which the systems and methods of the invention can be implemented;

FIG. 7 is a schematic diagram showing an exemplary communications network in which the method of the invention can be practiced;

FIG. 8 is a screenshot of the login screen of the gaming technology training and skill development system;

FIG. 9 is a screenshot of the certification path screen of the gaming technology training and skill development system;

FIG. 10 is a screenshot of the my professional development screen of the gaming technology training and skill development system;

FIG. 11 is a screenshot of the course catalog screen of the gaming technology training and skill development system;

FIG. 12 is a screenshot of the my training screen of the gaming technology training and skill development system; and

FIG. 13 is a screenshot of the transcript screen of the gaming technology training and skill development system.

### DESCRIPTION OF THE EMBODIMENTS

### Example Operating Environment

### Example Wagering Game Machine Architecture

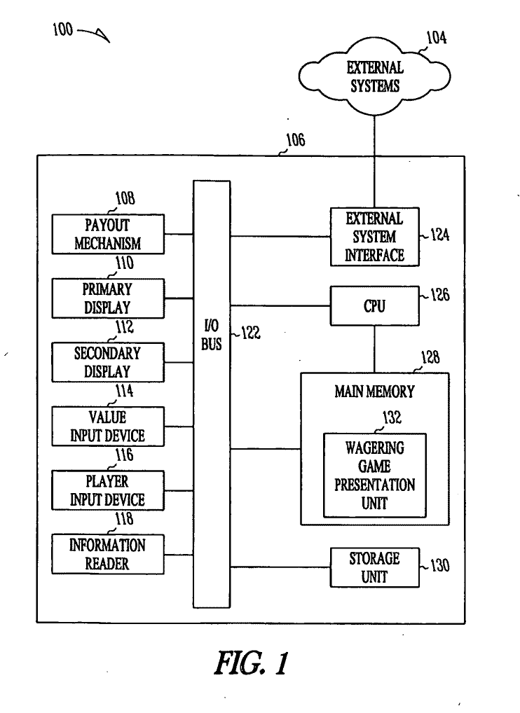

FIG. 1 is a block diagram illustrating a wagering game machine architecture, including a control system, according to example embodiments of the invention. As shown in FIG. 1, the wagering game machine 106 includes a central processing unit (CPU) 126 connected to main memory 128, which includes a wagering game presentation unit 132. In one embodiment, the wagering game presentation unit 132 can present wagering games, such as video poker, video black jack, video slots, video lottery, etc., in whole or part.

The CPU 126 is also connected to an input/output (I/O) bus 122, which facilitates communication between the wagering game machine's components. The I/O bus 122 is connected to a payout mechanism 108, primary display 110, secondary display 112, value input device 114, player input device 116, information reader 118, and storage unit 130. The player input device 116 can include the value input device 114 to the extent the player input device 116 is used to place wagers. The I/O bus 122 is also connected to an external system interface 124, which is connected to external systems 104 (e.g., wagering game networks).

In one embodiment, the wagering game machine 106 can include additional peripheral devices and/or more than one of each component shown in FIG. 1. For example, in one embodiment, the wagering game machine 106 can include multiple external system interfaces 124 and multiple CPUs 126. In one embodiment, any of the components can be integrated or subdivided. Additionally, in one embodiment, the components of the wagering game machine 106 can be interconnected according to any suitable interconnection architecture (e.g., directly connected, hypercube, etc.).

In one embodiment, any of the components of the wagering game machine 106 can include hardware, firmware, and/or software for performing the operations described herein. Machine-readable media includes any mechanism that provides (e.g., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

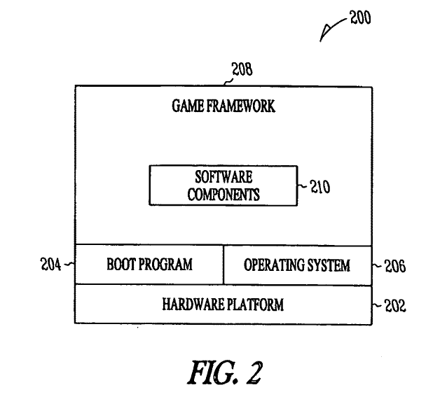

Referring now to FIG. 2, there is illustrated a block diagram of an architecture for a wagering game machine 200, according to example embodiments of the inventive subject matter. As shown in FIG. 2, the wagering game architecture includes a hardware platform 202, a boot program 204, an operating system 206, and a game framework 208 that includes one or more wagering game software components 210. In various embodiments, the hardware platform 202 may include a thin-client, thick-client, or some intermediate derivation. The hardware platform 202 may also be configured to provide a virtual client. The boot program 204 may include a basic input/output system (BIOS) or other initialization program that works in conjunction with the operation system 206 to provide a software interface to the hardware platform 202. The game framework 208 may include standardized game software components either independent or in combination with specialized or customized game software components that are designed for a particular wagering game. In one example embodiment, the wagering game software components 210 may include software operative in connection with the hardware platform 202 and operating system 206 to present wagering games, such as video poker, video black jack, video slots, video lottery, etc., in whole or part. According to another example embodiment, the software components 210 may include software operative to accept a wager from a player. According to another example embodiment, one or more of the software components 210 may be provided as part of the operating system 206 or other software used in the wagering game system 200 (e.g., libraries, daemons, common services, etc.).

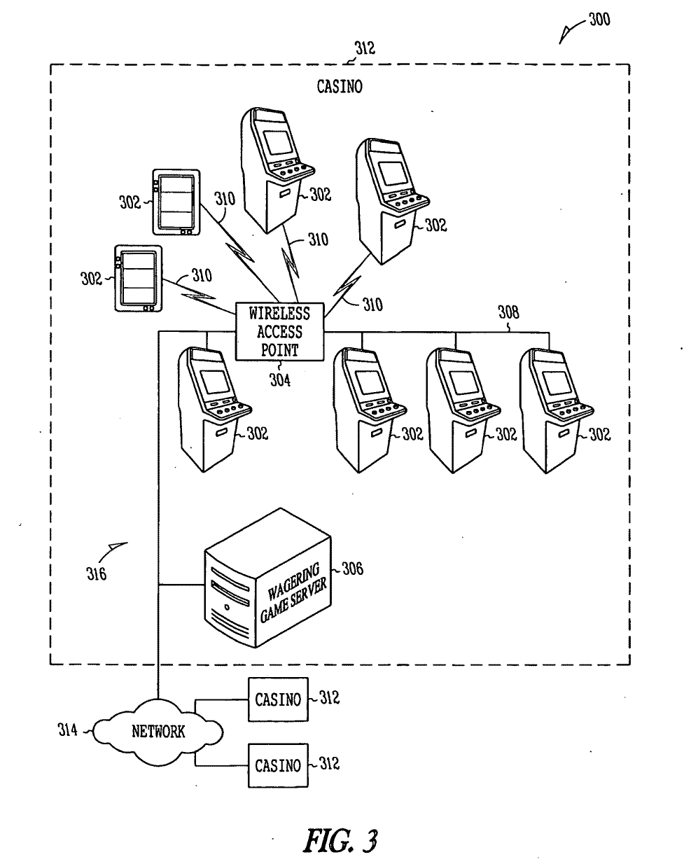

While FIGS. 1 and 2 describe example embodiments of a wagering game machine architecture, FIG. 3 shows how a plurality of wagering game machines can be connected in a wagering game network.

### Example Wagering Game Network

FIG. 3 is a block diagram illustrating a wagering game network 300, according to example embodiments of the invention. As shown in FIG. 3, the wagering game network 300 includes a plurality of casinos 312 connected to a communications network 314.

Each of the plurality of casinos 312 includes a local area network 316, which may include a wireless access point 304, wagering game machines 302, and a wagering game server 306 that can serve wagering games over the local area network 316. As such, the local area network 316 includes wireless communication links 310 and wired communication links 308. The wired and wireless communication links can employ any suitable connection technology, such as Bluetooth, 802.11, Ethernet, public switched telephone networks, SONET, etc. In one embodiment, the wagering game server 306 can serve wagering games and/or distribute content to devices located in other casinos 312 or at other locations on the communications network 314.

The wagering game machines 302 and wagering game server 306 can include hardware and machine-readable media including instructions for performing the operations described herein.

The wagering game machines 302 described herein can take any suitable form, such as floor standing models, handheld mobile units, bartop models, workstation-type console models, etc. Further, the wagering game machines 302 can be primarily dedicated for use in conducting wagering games, or can include non-dedicated devices, such as mobile phones, personal digital assistants, personal computers, etc. In one embodiment, the wagering game network 300 can include other network devices, such as accounting servers, wide area progressive servers, player tracking servers, and/or other devices suitable for use in connection with embodiments of the invention.

In various embodiments, wagering game machines 302 and wagering game servers 306 work together such that a wagering game machine 302 may be operated as a thin, thick, or intermediate client. For example, one or more elements of game play may be controlled by the wagering game machine 302 (client) or the wagering game server 306 (server). Game play elements may include executable game code, lookup tables, configuration files, game outcome, audio or visual representations of the game, game assets or the like. In a thin-client example, the wagering game server 306 may perform functions such as determining game outcome or managing assets, while the wagering game machine 302 may be used merely to present the graphical representation of such outcome or asset modification to the user (e.g., player). In a thick-client example, game outcome may be determined locally (e.g., at the wagering game machine 302) and then communicated to the wagering game server 306 for recording or managing a player's account.

Similarly, functionality not directly related to game play may be controlled by the wagering game machine 302 (client) or the wagering game server 306 (server) in embodiments. For example, power conservation controls that manage a display screen's light intensity may be managed centrally (e.g., by the wagering game server 306) or locally (e.g., by the wagering game machine 302). Other functionality not directly related to game play may include presentation of advertising, software or firmware updates, system quality or security checks, etc.

### Example Wireless Environment

In some embodiments, the wireless access point 304 and wagering game machines 302 can communicate orthogonal frequency division multiplexed (OFDM) communication signals over a multicarrier communication channel. The multicarrier communication channel can be within a predetermined frequency spectrum and can comprise a plurality of orthogonal subcarriers. In some embodiments, the multicarrier signals can be defined by closely spaced OFDM subcarriers. Each subcarrier can have a null at substantially a center frequency of the other subcarriers and/or each subcarrier can have an integer number of cycles within a symbol period. In some embodiments, the wireless access point 304 and wagering game machines 302 can communicate in accordance with a broadband multiple access technique, such as orthogonal frequency division multiple access (OFDMA). In some embodiments, the wireless access point 304 and wagering game machines 302 can communicate using spread-spectrum signals.

In some embodiments, the wireless access point 304 can be part of a communication station, such as wireless local area network (WLAN) communication station including a Wireless Fidelity (WiFi) communication station, or a WLAN access point (AP). In these embodiments, the wagering game machines 302 can be part of a mobile station, such as WLAN mobile station or a WiFi mobile station.

In some other embodiments, the wireless access point 304 can be part of a broadband wireless access (BWA) network communication station, such as a Worldwide Interoperability for Microwave Access (WiMax) communication station, as the wireless access point 304 can be part of almost any wireless communication device. In these embodiments, the wagering game machines 302 can be part of a BWA network communication station, such as a WiMax communication station.

In some embodiments, any of the wagering game machines 302 can part of a portable wireless communication device, such as a personal digital assistant (PDA), a laptop or portable computer with wireless communication capability, a web tablet, a wireless telephone, a wireless headset, a pager, an instant messaging device, a digital camera, a television, a medical device (e.g., a heart rate monitor, a blood pressure monitor, etc.), or other device that can receive and/or transmit information wirelessly.

In some embodiments, the frequency spectrums for the communication signals transmitted and received by the wireless access point 304 and the wagering game machines 302 can comprise either a 5 gigahertz (GHz) frequency spectrum or a 2.4 GHz frequency spectrum. In these embodiments, the 5 GHz frequency spectrum can include frequencies ranging from approximately 4.9 to 5.9 GHz, and the 2.4 GHz spectrum can include frequencies ranging from approximately 2.3 to 2.5 GHz, but other frequency spectrums are also equally suitable. In some BWA network embodiments, the frequency spectrum for the communication signals can comprise frequencies between 2 and 11 GHz.

In some embodiments, the wireless access point 304 and the wagering game machines 302 can communicate RF signals in accordance with specific communication standards, such as the Institute of Electrical and Electronics Engineers (IEEE) standards including IEEE 802.11(a), 802.11(b), 802.11(g), 802.11(h) and/or 802.11(n) standards and/or proposed specifications for wireless local area networks, but they can also be suitable to transmit and/or receive communications in accordance with other techniques and standards. In some BWA network embodiments, the wireless access point 304 and the wagering game machines 302 can communicate RF signals in accordance with the IEEE 802.16-2004 and the IEEE 802.16(e) standards for wireless metropolitan area networks (WMANs) including variations and evolutions thereof. However, they can also be suitable to transmit and/or receive communications in accordance with other techniques and standards. For more information with respect to the IEEE 802.11 and IEEE 802.16 standards, please refer to “IEEE Standards for Information Technology—Telecommunications and Information Exchange between Systems”—Local Area Networks—Specific Requirements—Part 11 “Wireless LAN Medium Access Control (MAC) and Physical Layer (PHY), ISO/IEC 8802-11: 1999”, and Metropolitan Area Networks—Specific Requirements—Part 16: “Air Interface for Fixed Broadband Wireless Access Systems,” Can 2005 and related amendments/versions.

In some embodiments, the wireless access point 304 and the wagering game machines 302 can include one or more antennas (not shown). These antennas can comprise directional or omnidirectional antennas, including, for example, dipole antennas, monopole antennas, patch antennas, loop antennas, microstrip antennas or other types of antennas suitable for transmission of the RF signals. In some multiple-input, multiple-output (MIMO) embodiments, two or more antennas can be used. In some embodiments, instead of two or more antennas, a single antenna with multiple apertures can be used. In these multiple aperture embodiments, each aperture can be considered a separate antenna. In some multi-antenna embodiments, each antenna can be effectively separated to take advantage of spatial diversity and the different channel characteristics that can result between each of the antennas and another wireless communication device. In some multi-antenna embodiments, the antennas of a device can be separated by up to 1/10 of a wavelength or more.

In some embodiments, handoffs between different wireless access points 104 and one of the wagering game machines 302 can be performed based on a signal-to-noise ratio (SNR), a signal-to-noise and interference ratio (SNIR), a bit-error rate (BER), or an energy per received bit.

In some embodiments, the wireless access point 304 and the wagering game machines 302 can communicate in accordance with standards such as the Pan-European mobile system standard referred to as the Global System for Mobile Communications (GSM). In some embodiments, the wireless access point 304 and the wagering game machines 302 can also communicate in accordance with packet radio services such as the General Packet Radio Service (GPRS) packet data communication service. In some embodiments, the wireless access point 304 and the wagering game machines 302 can communicate in accordance with the Universal Mobile Telephone System (UMTS) for the next generation of GSM, which can, for example, implement communication techniques in accordance with 2.5G and third generation (3G) wireless standards (See 3GPP Technical Specification, Version 3.2.0, March 2000). In some of these embodiments, the wireless access point 304 and the wagering game machines 302 can provide packet data services (PDS) utilizing packet data protocols (PDP). In other embodiments, the wireless access point 304 and the wagering game machines 302 can communicate in accordance with other standards or other air-interfaces including interfaces compatible with the enhanced data for GSM evolution (EDGE) standards (see 3GPP Technical Specification, Version 3.2.0, March 2000).

In other embodiments, the wireless access point 304 and the wagering game machines 302 can communicate in accordance with a short-range wireless standard, such as the Bluetooth™ short-range digital communication protocol. Bluetooth™ wireless technology is a de facto standard, as well as a specification for small-form factor, low-cost, short-range radio links between mobile PCs, mobile phones and other portable devices. (Bluetooth is a trademark owned by Bluetooth SIG, Inc.) In other embodiments, the wireless access point 304 and the wagering game machines 302 can communicate in accordance with an ultra-wideband (UWB) communication technique where a carrier frequency is not used. In other embodiments, the wireless access point 304 and the wagering game machines 302 can communicate in accordance with an analog communication technique. In other embodiments, the wireless access point 304 and the wagering game machines 302 can communicate in accordance with an optical communication technique, such as the Infrared Data Association (IrDA) standard. In some embodiments, the wireless access point 304 and the wagering game machines 302 can communicate in accordance with the Home-RF standard which can be in accordance with a Home-RF Working Group (HRFWG) standard.

### Example Wagering Game Machines

### Example Wagering Game Machine

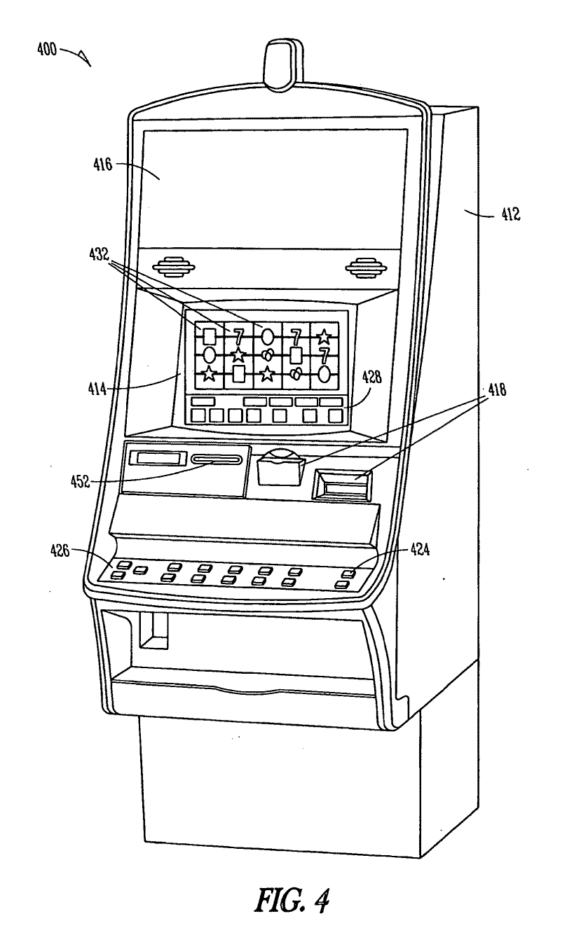

FIG. 4 is a perspective view of a wagering game machine, according to example embodiments of the invention. Referring to FIG. 4, a wagering game machine 400 is used in gaming establishments, such as casinos. According to embodiments, the wagering game machine 400 can be any type of wagering game machine and can have varying structures and methods of operation. For example, the wagering game machine 400 can be an electromechanical wagering game machine configured to play mechanical slots, or it can be an electronic wagering game machine configured to play video casino games, such as blackjack, slots, keno, poker, blackjack, roulette, etc.

The wagering game machine 400 comprises a housing 412 and includes input devices, including value input devices 418 and a player input device 424. For output, the wagering game machine 400 includes a primary display 414 for displaying information about a basic wagering game. The primary display 414 can also display information about a bonus wagering game and a progressive wagering game. The wagering game machine 400 also includes a secondary display 416 for displaying wagering game events, wagering game outcomes, and/or signage information. While some components of the wagering game machine 400 are described herein, numerous other elements can exist and can be used in any number or combination to create varying forms of the wagering game machine 400.

The value input devices 418 can take any suitable form and can be located on the front of the housing 412. The value input devices 418 can receive currency and/or credits inserted by a player. The value input devices 418 can include coin acceptors for receiving coin currency and bill acceptors for receiving paper currency. Furthermore, the value input devices 418 can include ticket readers or barcode scanners for reading information stored on vouchers, cards, or other tangible portable storage devices. The vouchers or cards can authorize access to central accounts, which can transfer money to the wagering game machine 400.

The player input device 424 comprises a plurality of push buttons on a button panel 426 for operating the wagering game machine 400. In addition, or alternatively, the player input device 424 can comprise a touch screen 428 mounted over the primary display 414 and/or secondary display 416.

The various components of the wagering game machine 400 can be connected directly to, or contained within, the housing 412. Alternatively, some of the wagering game machine's components can be located outside of the housing 412, while being communicatively coupled with the wagering game machine 400 using any suitable wired or wireless communication technology.

The operation of the basic wagering game can be displayed to the player on the primary display 414. The primary display 414 can also display a bonus game associated with the basic wagering game. The primary display 414 can include a cathode ray tube (CRT), a high resolution liquid crystal display (LCD), a plasma display, light emitting diodes (LEDs), or any other type of display suitable for use in the wagering game machine 400. Alternatively, the primary display 414 can include a number of mechanical reels to display the outcome. In FIG. 4, the wagering game machine 400 is an “upright” version in which the primary display 414 is oriented vertically relative to the player. Alternatively, the wagering game machine can be a “slant-top” version in which the primary display 414 is slanted at about a thirty-degree angle toward the player of the wagering game machine 400. In yet another embodiment, the wagering game machine 400 can exhibit any suitable form factor, such as a free standing model, bartop model, mobile handheld model, or workstation console model.

A player begins playing a basic wagering game by making a wager via the value input device 418. The player can initiate play by using the player input device's buttons or touch screen 428. The basic game can include arranging a plurality of symbols along a payline 432, which indicates one or more outcomes of the basic game. Such outcomes can be randomly selected in response to player input. At least one of the outcomes, which can include any variation or combination of symbols, can trigger a bonus game.

In some embodiments, the wagering game machine 400 can also include an information reader 452, which can include a card reader, ticket reader, bar code scanner, RFID transceiver, or computer readable storage medium interface. In some embodiments, the information reader 452 can be used to award complimentary services, restore game assets, track player habits, etc.

### Example Wagering Game Machine

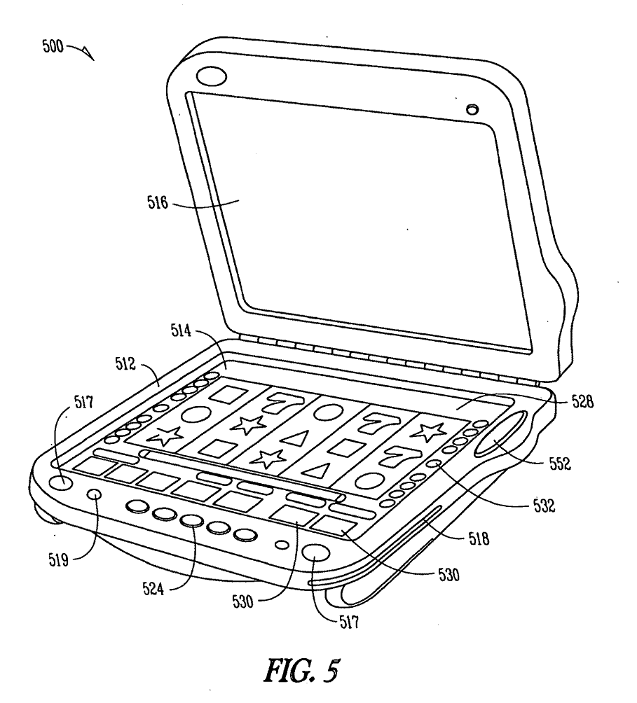

FIG. 5 shows an example embodiment of a wagering game machine 500. Like free standing wagering game machines, in a handheld or mobile form, the wagering game machine 500 can include any suitable electronic device configured to play a video casino games such as blackjack, slots, keno, poker, blackjack, and roulette. The wagering game machine 500 comprises a housing 512 and includes input devices, including a value input device 518 and a player input device 524. For output, the wagering game machine 500 includes a primary display 514, a secondary display 516, one or more speakers 517, one or more player-accessible ports 519 (e.g., an audio output jack for headphones, a video headset jack, etc.), and other conventional I/O devices and ports, which may or may not be player-accessible. In the embodiment depicted in FIG. 5, the wagering game machine 500 comprises a secondary display 516 that is rotatable relative to the primary display 514. The optional secondary display 516 can be fixed, movable, and/or detachable/attachable relative to the primary display 514. Either the primary display 514 and/or secondary display 516 can be configured to display any aspect of a non-wagering game, wagering game, secondary game, bonus game, progressive wagering game, group game, shared-experience game or event, game event, game outcome, scrolling information, text messaging, emails, alerts or announcements, broadcast information, subscription information, and wagering game machine status.

The player-accessible value input device 518 can comprise, for example, a slot located on the front, side, or top of the housing 512 configured to receive credit from a stored-value card (e.g., casino card, smart card, debit card, credit card, etc.) inserted by a player. The player-accessible value input device 518 can also comprise a sensor (e.g., an RF sensor) configured to sense a signal (e.g., an RF signal) output by a transmitter (e.g., an RF transmitter) carried by a player. The player-accessible value input device 518 can also or alternatively include a ticket reader, or barcode scanner, for reading information stored on a credit ticket, a card, or other tangible portable credit or funds storage device. The credit ticket or card can also authorize access to a central account, which can transfer money to the wagering game machine 500.

Still other player-accessible value input devices 518 can require the use of touch keys 530 on the touch-screen display (e.g., primary display 514 and/or secondary display 516) or player input devices 524. Upon entry of player identification information and, preferably, secondary authorization information (e.g., a password, PIN number, stored value card number, predefined key sequences, etc.), the player can be permitted to access a player's account. As one potential optional security feature, the wagering game machine 500 can be configured to permit a player to only access an account the player has specifically set up for the wagering game machine 500. Other conventional security features can also be utilized to, for example, prevent unauthorized access to a player's account, to minimize an impact of any unauthorized access to a player's account, or to prevent unauthorized access to any personal information or funds temporarily stored on the wagering game machine 500.

The player-accessible value input device 518 can itself comprise or utilize a biometric player information reader which permits the player to access available funds on a player's account, either alone or in combination with another of the aforementioned player-accessible value input devices 518. In an embodiment wherein the player-accessible value input device 518 comprises a biometric player information reader, transactions such as an input of value to the wagering game machine 500, a transfer of value from one player account or source to an account associated with the wagering game machine 500, or the execution of another transaction, for example, could all be authorized by a biometric reading, which could comprise a plurality of biometric readings, from the biometric device.

Alternatively, to enhance security, a transaction can be optionally enabled only by a two-step process in which a secondary source confirms the identity indicated by a primary source. For example, a player-accessible value input device 518 comprising a biometric player information reader can require a confirmatory entry from another biometric player information reader 552, or from another source, such as a credit card, debit card, player ID card, fob key, PIN number, password, hotel room key, etc. Thus, a transaction can be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 518 can be provided remotely from the wagering game machine 500.

The player input device 524 comprises a plurality of push buttons on a button panel for operating the wagering game machine 500. In addition, or alternatively, the player input device 524 can comprise a touch screen mounted to a primary display 514 and/or secondary display 516. In one aspect, the touch screen is matched to a display screen having one or more selectable touch keys 530 selectable by a user's touching of the associated area of the screen using a finger or a tool, such as a stylus pointer. A player enables a desired function either by touching the touch screen at an appropriate touch key 530 or by pressing an appropriate push button on the button panel. The touch keys 530 can be used to implement the same functions as push buttons. Alternatively, the push buttons 532, can provide inputs for one aspect of the operating the game, while the touch keys 530 can allow for input needed for another aspect of the game. The various components of the wagering game machine 500 can be connected directly to, or contained within, the housing 512, as seen in FIG. 5, or can be located outside the housing 512 and connected to the housing 512 via a variety of wired (tethered) or wireless connection methods. Thus, the wagering game machine 500 can comprise a single unit or a plurality of interconnected (e.g., wireless connections) parts which can be arranged to suit a player's preferences.

The operation of the basic wagering game on the wagering game machine 500 is displayed to the player on the primary display 514. The primary display 514 can also display the bonus game associated with the basic wagering game. The primary display 514 preferably takes the form of a high resolution LCD, a plasma display, an LED, or any other type of display suitable for use in the wagering game machine 500. The size of the primary display 514 can vary from, for example, about a 2-3″ display to a 15″ or 17″ display. In at least some embodiments, the primary display 514 is a 7″-10″ display. In one embodiment, the size of the primary display can be increased. Optionally, coatings or removable films or sheets can be applied to the display to provide desired characteristics (e.g., anti-scratch, anti-glare, bacterially-resistant and anti-microbial films, etc.). In at least some embodiments, the primary display 514 and/or secondary display 516 can have a 16:9 aspect ratio or other aspect ratio (e.g., 4:3). The primary display 514 and/or secondary display 516 can also each have different resolutions, different color schemes, and different aspect ratios.

As with the free standing embodiments a wagering gaming machine, a player begins play of the basic wagering game on the wagering game machine 500 by making a wager (e.g., via the value input device 418 or an assignment of credits stored on the handheld gaming machine via the touch screen keys 530, player input device 524, or buttons 532) on the wagering game machine 500. In some embodiments, the basic game can comprise a plurality of symbols arranged in an array, and includes at least one payline 528 that indicates one or more outcomes of the basic game. Such outcomes can be randomly selected in response to the wagering input by the player. At least one of the plurality of randomly selected outcomes can be a start-bonus outcome, which can include any variations of symbols or symbol combinations triggering a bonus game.

In some embodiments, the player-accessible value input device 518 of the wagering game machine 500 can double as a player information reader 552 that allows for identification of a player by reading a card with information indicating the player's identity (e.g., reading a player's credit card, player ID card, smart card, etc.). The player information reader 552 can alternatively or also comprise a bar code scanner, RFID transceiver or computer readable storage medium interface. In one embodiment, the player information reader 552 comprises a biometric sensing device.

### Example Computing Device and Communications Network

### Example Computing Device

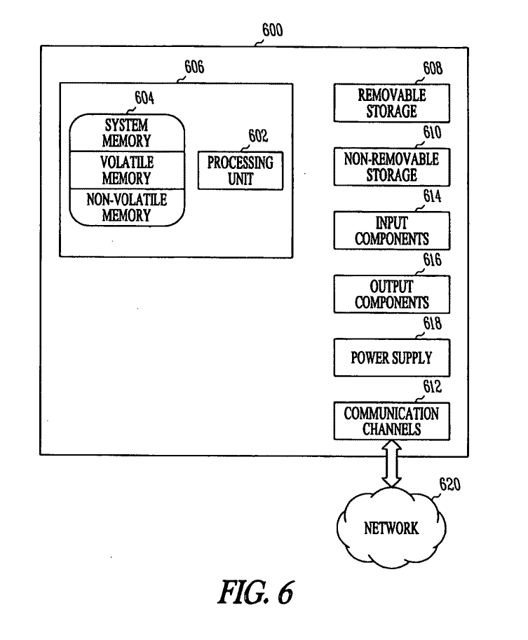

Referring to FIG. 6, the present invention relates to a gaming technology training and skill development system accessed on a computing device. The computing device may have one of many different computer architectures. For descriptive purposes, FIG. 6 shows a schematic diagram of an exemplary architecture usable for these devices. The architecture portrayed is only one example of a suitable environment and is not intended to suggest any limitation as to the scope of use or functionality of the invention. Neither should the computing devices be interpreted as having any dependency or requirement relating to any one or combination of components illustrated in FIG. 6. The invention is operational with numerous other general-purpose or special-purpose computing or communications environments or configurations. Examples of well known computing systems, environments, and configurations suitable for use with the invention include, but are not limited to, mobile telephones, pocket computers, personal computers, servers, multiprocessor systems, microprocessor-based systems, minicomputers, mainframe computers, and distributed computing environments that include any of the above systems or devices.

In its most basic configuration, a computing device 600 typically includes at least one processing unit 602 and memory 604. The memory 604 may be volatile (such as RAM), non-volatile (such as ROM and flash memory), or some combination of the two. This most basic configuration is illustrated in FIG. 6 by the dashed line 606.

Computing device 600 can also contain storage media devices 608 and 610 that may have additional features and functionality. For example, they may include additional storage (removable and non-removable) including, but not limited to, PCMCIA cards, magnetic and optical disks, and magnetic tape. Such additional storage is illustrated in FIG. 6 by removable storage 608 and non-removable storage 610. Computer-storage media include volatile and non-volatile, removable and non-removable media implemented in any method or technology for storage of information such as computer-readable instructions, data structures, program modules, or other data. Memory 604, removable storage 608, and non-removable storage 610 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, and any other media that can be used to store the desired information and that can be accessed by the computing device.

Computing device 600 can also contain communication channels 612 that allow it to communicate with other devices. Communication channels 612 are examples of communications media. Communications media typically embody computer-readable instructions, data structures, program modules, or other data in a modulated data signal such as a carrier wave or other transport mechanism and include any information-delivery media. The term “modulated data signal” means a signal that has one or more of its characteristics set or changed in such a manner as to encode information in the signal. By way of example, and not limitation, communications media include wired media, such as wired networks and direct-wired connections, and wireless media such as acoustic, radio, infrared, and other wireless media. The term computer-readable media as used herein includes both storage media and communications media. The computing device 600 may also have input components 614 such as a keyboard, mouse, pen, a voice-input component, and a touch-input device. Output components 616 include screen displays, speakers, printers, and rendering modules (often called “adapters”) for driving them. The computing device 600 has a power supply 618. All these components are well known in the art and need not be discussed at length here.

### Example Communications Network

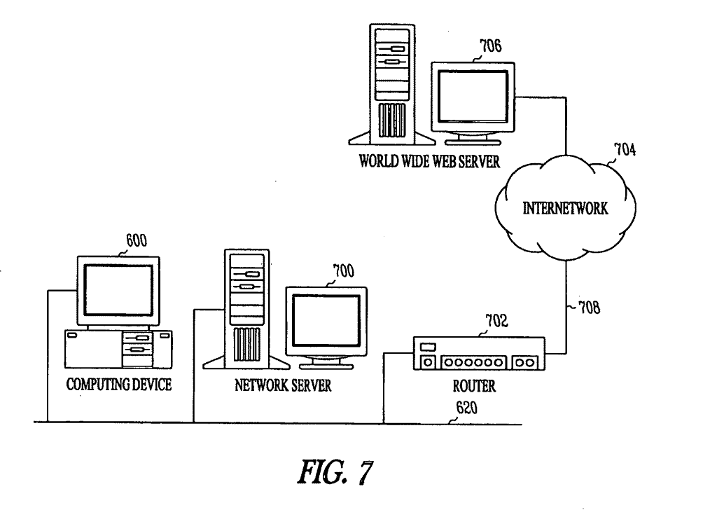

The present invention is directed to systems and methods for gaming technology training and skill development accessed on a computing device which may be received over a computer network. Referring to FIG. 7, an exemplary communications network architecture is illustrated. Accompanying a computing device 600 on a local area network (LAN) 620 is a server 700 and a router 702. The router 702 allows the devices on the LAN 620 to communicate over an internetwork 704 to remote computing devices 706. The Internet is one example of an internetwork. In the present example, the server 700 can be a network server which the computing device 600 may access for proxy services to connect to the Internet over the LAN 620 and the remote computing device can be a server which the computing device may access for search results over the Internet 704 or similar wide area network (WAN). The server 700 may also be a network file server or local area network Internet (intranet) server which the computing device 600 accesses.

### Example Operations

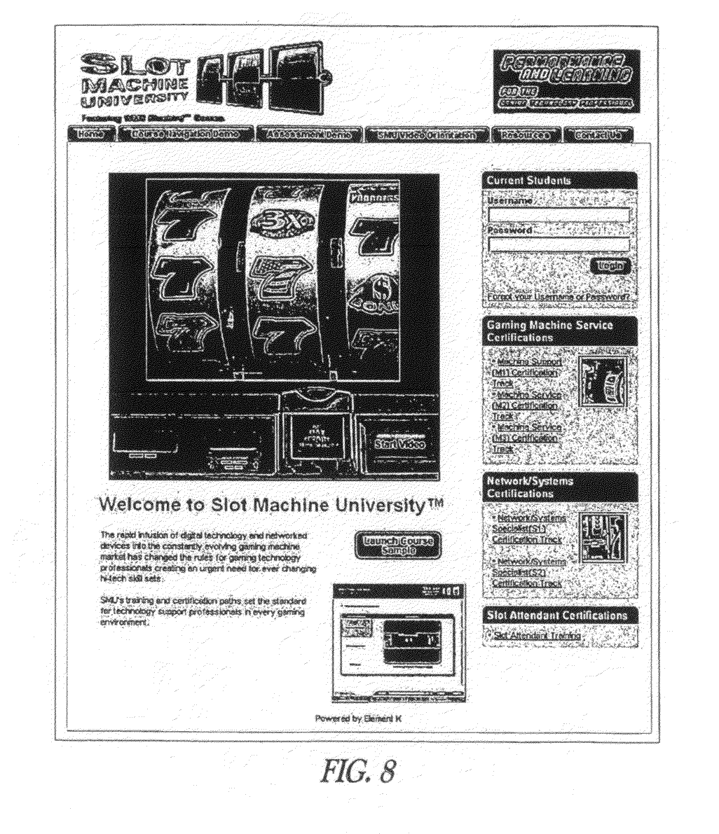

The present invention provides a gaming technology training and skill development system accessed on a computing device. FIGS. 8 through 13 illustrate basic operations that the gaming technology training and skill development system can perform.

As will be appreciated by one of ordinary skill in the art, the gaming technology training and skill development system of the present invention can be an interactive multimedia-based application. The system can be accessed at almost any time and from almost anywhere a computing device may be located. Furthermore, the system can operate to present its materials in a user-paced and on-demand fashion.

The gaming technology training and skill development system of the present invention allows for the system operator to bundle courses of specific interest together to form certification tracks. Additionally, the system allows the operator to assign certification exams to the certification tracks, the certification exams may feature exercises which mimic or faithfully replicate the practical exercises which they endeavor to test.

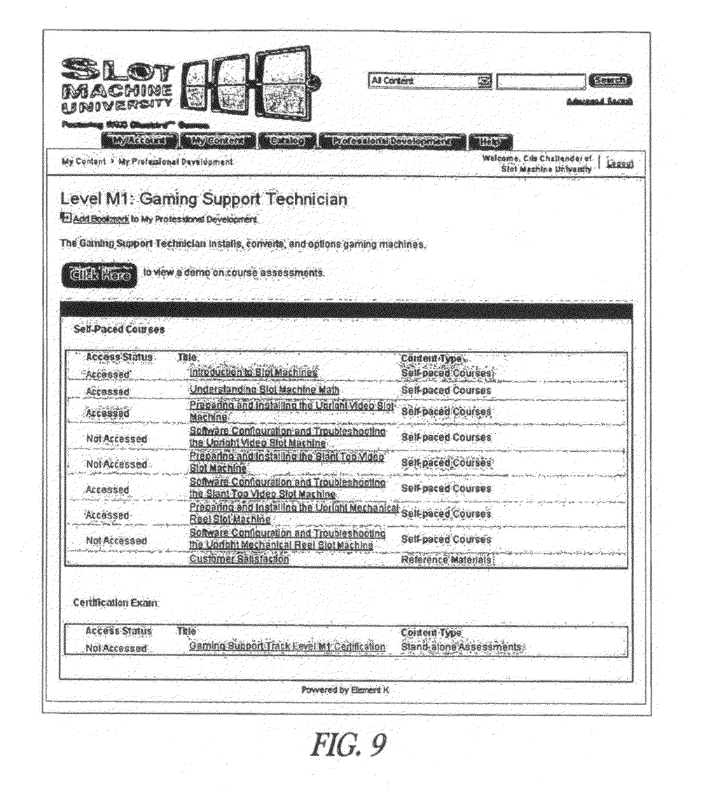

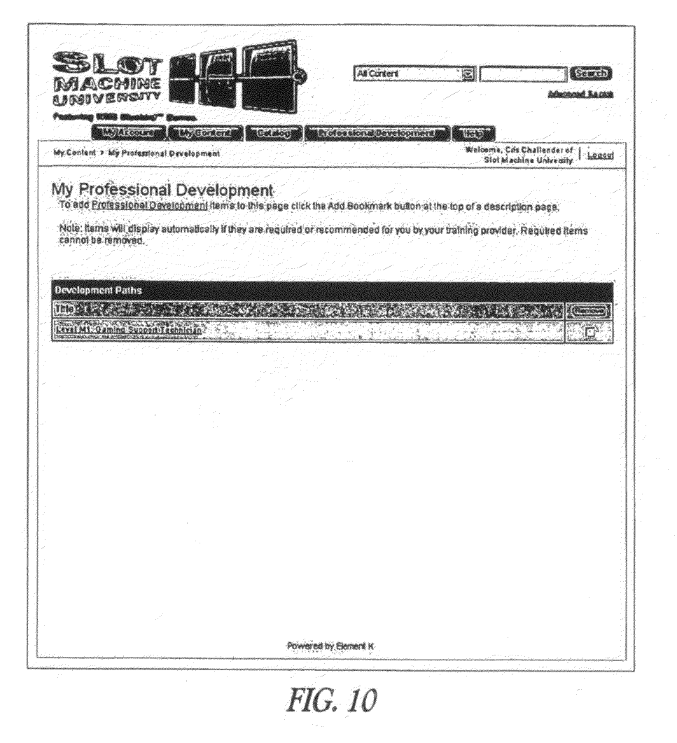

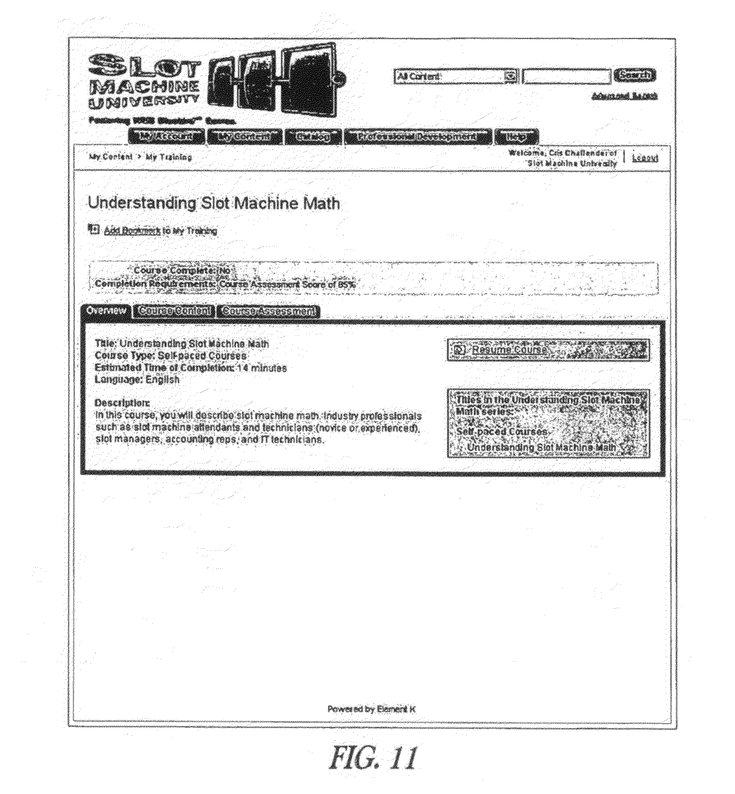

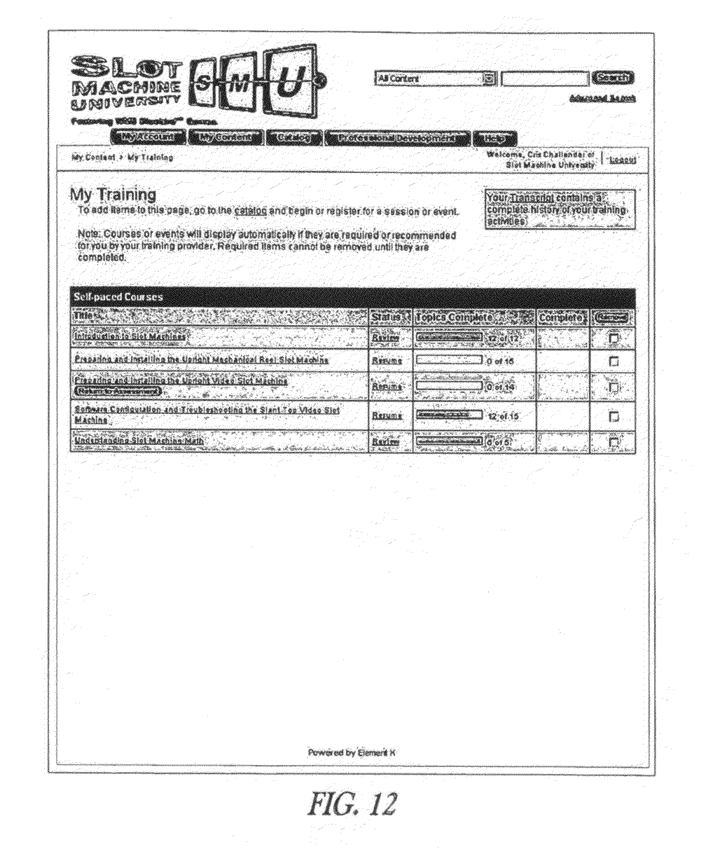

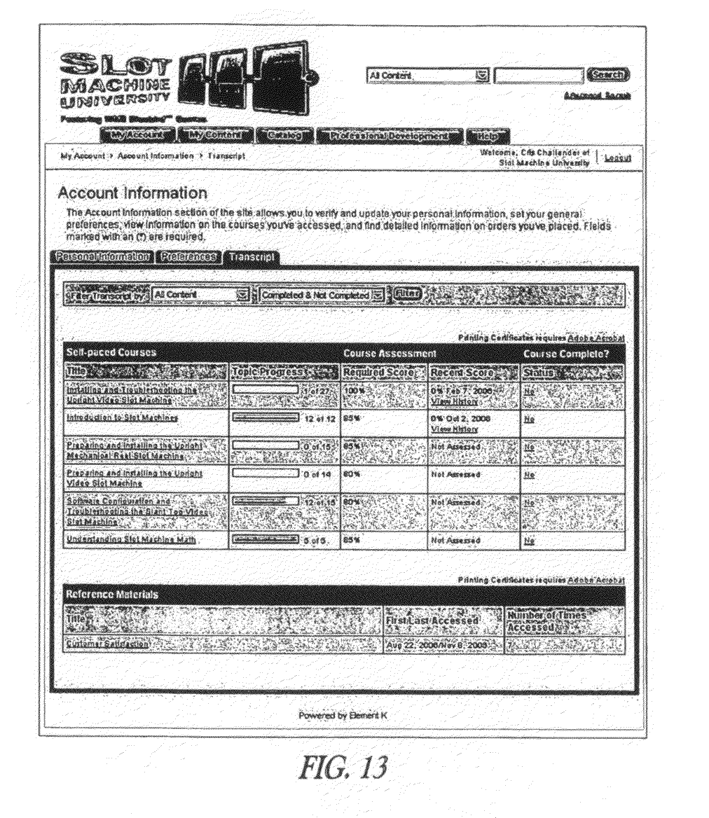

Beginning with FIG. 8, the user is presented with a login screen to enter the gaming technology training and skill development system. At FIG. 9 the user can view the activities the system operator has specified to be completed for the certification track. At this screen the user can also, if they desire, add the selected certification track to their “My Professional Development” profile, as pictured in FIG. 10. In FIG. 11, the user may access course catalog content. At this screen the user can also, if they desire, add the selected course content to their “My Training” profile, as pictured in FIG. 12. Finally, as pictured in FIG. 13, the system can maintain a transcript of courses and reference materials for the user and offer the ability to filter the transcript according to type of material and, in the case of courses, state of completion.

Because the system is designed as with a flexible architecture the system operator can choose and continually update the content that is required for each certification track. Furthermore since the system maintains records for the users, the system operator can run reports that track user's activity and monitor progress real-time.

### General

In this detailed description, reference is made to specific examples by way of drawings and illustrations. These examples are described in sufficient detail to enable those skilled in the art to practice the inventive subject matter, and serve to illustrate how the inventive subject matter can be applied to various purposes or embodiments. Other embodiments are included within the inventive subject matter, as logical, mechanical, electrical, and other changes can be made to the example embodiments described herein. Features or limitations of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims.

Various modules exist within the computerized system and within other embodiments of the invention, and such modules may comprise in various embodiments hardware, software, or any combination thereof. Some modules may further comprise or require outside interaction, such as with a user, another system, or external signals.

Each of the embodiments described herein are contemplated as falling within the inventive subject matter, which is set forth in the following claims.

What is claimed is:

1. A computer system having a graphical user interface including a display, a user input device, and a training module operable to provide gaming technology training and skill development, the training module operable to:
(a) retrieve one or more course certification tracks, the course certification tracks having a specified set of one or more course exercise items associated therewith;
(b) display the course certification tracks on the display;
(c) receive an execution signal indicative of a user selecting a course certification track or a course exercise item, and in response to the execution signal, to perform a specified default command.

2. The computer system of claim 1, the training module further operable to receive an execution signal indicative of a user selecting a course certification track for adding to a course certification profile, and in response to the execution signal, operable to perform a specified default command.

3. The computer system of claim 1, the training module further operable to receive an execution signal indicative of a user selecting a course exercise item for adding to a course exercise item profile, and in response to the execution signal, operable to perform a specified default command.

4. The computer system of claim 1, the training module further operable to maintain a list of completed course certification tracks and course exercise items, the list being filterable on attributes of the course certification tracks and course exercise items.

5. A method of providing gaming technology training and skill development in a computer system having a graphical user interface including a display and a user input device, the method comprising:
(a) retrieving one or more course certification tracks, the course certification tracks having a specified set of one or more course exercise items associated therewith;
(b) displaying the course certification tracks on the display;
(c) receiving an execution signal indicative of a user selecting a course certification track or a course exercise item, and in response to the execution signal, performing a specified default command.

6. The method of claim 5, further comprising receiving an execution signal indicative of a user selecting a course certification track for adding to a course certification profile, and in response to the execution signal, performing a specified default command.

7. The method of claim 5, further comprising receiving an execution signal indicative of a user selecting a course exercise item for adding to a course exercise item profile, and in response to the execution signal, performing a specified default command.

8. The method of claim 5, further comprising maintaining a list of completed course certification tracks and course exercise items, the list having the ability to be filtered on attributes of the course certification tracks and course exercise items.

9. A computer-readable medium having computer-executable instructions encoded thereon that when executed on a computerized system are operable to cause the computerized system to:
(a) retrieve one or more course certification tracks, the course certification tracks having a specified set of one or more course exercise items associated therewith;
(b) display the course certification tracks on the display;
(c) receive an execution signal indicative of a user selecting a course certification track or a course exercise item, and in response to the execution signal, to perform a specified default command.

10. The computer-readable medium of claim 9, the instructions when executed further operable to cause the computerized system to receive an execution signal indicative of a user selecting a course certification track for adding to a course certification profile, and in response to the execution signal, to perform a specified default command.

11. The computer-readable medium of claim 9, the instructions when executed further operable to cause the computerized system to receive an execution signal indicative of a user selecting a course exercise item for adding to a course exercise item profile, and in response to the execution signal, to performing a specified default command.

12. The computer-readable medium of claim 9, the instructions when executed further operable to cause the computerized system to maintain a list of completed course certification tracks and course exercise items, the list filterable on attributes of the course certification tracks and course exercise items.
